(19) United States
(12) Patent Application Publication
(10) Pub. No.: US 2026/0051267 A1
(43) Pub. Date: Feb. 19, 2026

(54) MODEL FOR SIMULATING A BRAIN SOFT TISSUE AFFECTED BY NEOPLASM AND USE

(71) Applicant: UPSURGEON S.R.L., Assago (Milano) (IT)

(72) Inventor: Federico NICOLOSI, Assago (Milano) (IT)

(21) Appl. No.: 19/102,454

(22) PCT Filed: Aug. 10, 2023
(86) PCT No.: PCT/IB2023/058096

§ 371 Date: Feb. 10, 2025

(30) Foreign Application Priority Data
Aug. 11, 2022 (IT) 102022000017217

(51) Int. Cl. G09B 23/30

(52) U.S. Cl. CPC G09B 23/30

(57) ABSTRACT

A model for simulating a brain soft tissue affected by neoplasm has a first portion for simulating a healthy tissue and a second portion for simulating a neoplastic tissue. The first portion and the second portion have a composition including water, gelatin, glycerin and sorbitol. The content by weight of glycerin and sorbitol is predominant over the content by weight of gelatin. The first portion has a liquid dye and the second portion has at least one powdered pigment.

### FIELD OF APPLICATION

The present invention applies to the field of devices that may be used in surgical training procedures.

### Prior Art

The training of qualified surgeons is a relevant issue to which significant resources are devoted each year within hospitals, research centers, and universities around the world, both in terms of time, cost and human resources.

Technological advances accompanying surgical practice have further highlighted the need for physicians to have constant access to models, platforms, and devices for practice and continuing education.

The ability to practice on models that are as faithful as possible to healthy and pathological human tissue, both for surgical planning and preoperative practice, is essential for acquiring the psychomotor skills necessary to operate with greater precision and accuracy, aspects that result in increased patient safety and reduced morbidity and mortality, as well as reducing the costs related thereto.

Although surgical training on animal models or cadaver preparations has traditionally been considered the “gold standard,” it is apparent that it is no longer sustainable to rely on these models alone, due to the high costs related thereto, which are a known limitation to continuous use. In addition, it is necessary to consider how in some countries, such as Muslim countries, the use of human cadavers for training purposes not allowed. Additionally, surgical training on cadaver preparations in no way ensures that a pathology is present in such a preparation. Therefore, surgical training for a specific pathology on a cadaver preparation is a rather rare event.

The issue is particularly relevant in branches of surgery with particularly slow learning curves and significant implications for the quality of care of patients with conditions at high risk of post-surgical morbidity and mortality, such as neurosurgery, spinal surgery, maxillofacial surgery and general surgery, cardiac surgery, thoracic surgery, gynecology, and others, in which the time and resources spent on learning prior to actual licensure have now come to represent a major cause of shortages of qualified personnel on a global scale.

There is therefore a strong need to rethink how to train the surgeons of the future and to make available innovative solutions for practicing surgical technique that are more accessible and sustainable in relation to a continuous use. In fact, repeatability of practice is one of the greatest features of effective practice, a concept valid in any human discipline. One possible approach lies in developing and

making accessible artificial anatomical models for simulating surgical scenarios capable of representing organs and adipose or connective tissues, either in healthy conditions or in specific pathological conditions such that sufficiently high fidelity in reproducing the morphological and physical features of human anatomy, as well as various pathological conditions, may be ensured. Such solutions could offer scenarios in which students and physicians could practice the steps of surgical procedures as realistically as possible, experiencing the same visual and tactile sensations that they would later find in real patient practice.

### Solution of the Invention

The object of the present invention is to provide a physical model for simulating a brain soft tissue that succeeds at least partially in solving the above-mentioned issues. In particular, the object of the present invention is to provide a model and a composition thereof having a rendering from a visual and tactile point of view as close as possible to the rendering of real brain soft tissue during a surgical procedure. Further, an object of the present invention is to provide a model that not only has a rendering from a visual and tactile point of view as close as possible to the rendering of a real brain soft tissue, but also is capable of ensuring that normal ultrasound imaging equipment may be used for the correct detection of neoplasm as compared to healthy tissue by such a technique.

In a first subject matter, the present invention describes a composition for making a simulation model for a brain soft tissue.

In a second subject matter, the present invention describes a method for producing a composition that may be used to make a model for simulating a brain soft tissue.

In a third subject matter, the present invention describes a model for simulating a brain soft tissue.

In a fourth subject matter, the present invention describes a model for simulating a brain soft tissue comprising a pathology, particularly affected by neoplasm.

### DESCRIPTION OF THE DRAWINGS

The features and the advantages of the invention according to the invention shall be made from the following description of readily apparent preferred example embodiments thereof, provided purely by way of a non-limiting example, with reference to the accompanying figures, in which:

FIG. 1 shows a model for simulating a brain soft tissue according to an embodiment of the invention;

FIG. 2 shows in a histogram a result of an questionnaire on the invention regarding the job positions of the subjects interviewed;

FIG. 3 shows in a pie chart another result of the questionnaire, regarding the years of experience of the subjects interviewed;

FIG. 4 shows in a pie chart another result of the questionnaire, regarding the number of tumor resections completed as the first operator by the subjects interviewed;

FIG. 5 shows in a pie chart another result of the questionnaire, regarding the number of tumor resections completed as first operator and as second operator by the subjects interviewed;

FIG. 6 shows in pie chart another result of the questionnaire, regarding the evaluation of surface anatomical accuracy of models for simulating a brain soft tissue according to embodiments of the invention;

FIG. 7 shows in a pie chart another result of the questionnaire, regarding the evaluation of the tactile sensation in manipulating models for simulating a brain soft tissue according to embodiments of the invention;

FIG. 8 shows in a pie chart another result of the questionnaire, regarding the evaluation of the visual appearance of the coloring of models for simulating a brain soft tissue according to embodiments of the invention;

FIG. 9 shows in a pie chart another result of the questionnaire, regarding the evaluation of the identification of a simulation portion of a neoplastic tissue in models for simulating a brain soft tissue according to embodiments of the invention;

FIG. 10 shows in a pie chart another result of the questionnaire, regarding the evaluation of the tactile sensation in manipulating models for simulating a brain soft tissue according to embodiments of the invention;

FIG. 11 shows in a pie chart another result of the questionnaire, regarding the evaluation of the visual appearance of the coloring of models for simulating a brain soft tissue according to embodiments of the invention;

FIG. 12 shows in a pie chart another result of the questionnaire, regarding the evaluation of the realism of the procedure of resection of a simulation portion of a neoplastic tissue in a model for simulating a brain soft tissue according to embodiments of the invention.

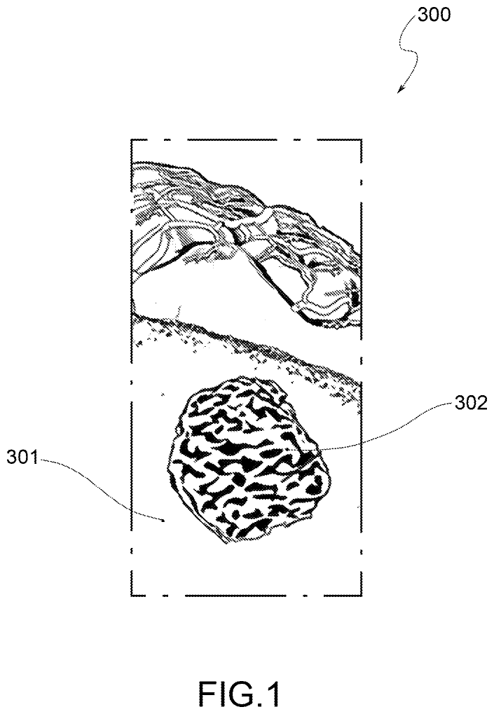

### DETAILED DESCRIPTION

The present invention pertains to a composition for making a model for simulating a brain soft tissue, comprising gelatin and, in a manner predominant by weight, a mixture of glycerin and sorbitol.

For the purposes of the present invention, it has been decided to indicate quantities by mass percentage, also known to the person skilled in the art as percent amount by weight and indicated by the symbol % (w/w), which corresponds to the amount by weight expressed in grams of the component of interest present in 100 g of total composition (total weight of the composition).

According to an embodiment of the invention, the gelatin and glycerin are in a ratio between 1:10 to 1:30 inclusive.

According to an embodiment, gelatin and

sorbitol are in a ratio between 1:10 and 1:30 inclusive.

According to an embodiment, gelatin is present in an amount at most equal to 10% (w/w), preferably at most 5% (w/w), even more preferably between 1% and 4% (w/w).

According to an embodiment, glycerin is present in an amount between 30% and 55% (w/w) inclusive, preferably between 35% and 50% (w/w) inclusive, even more preferably between 38% and 46% (w/w) inclusive.

According to an embodiment, sorbitol is present in an amount between 30% and 55% (w/w) inclusive, preferably between 35% and 50% (w/w) inclusive, even more preferably between 38% and 46% (w/w) inclusive.

Preferably, the gelatin is a 300 Bloom gelatin.

Bloom degree is a unit of measurement of the solidity of a gel. It is defined as the weight measured in grams required for a piston, normally 12.7 mm in diameter, to cause the gel surface to be lowered by 4 mm without breaking it. The gel, before being tested, must be prepared with a concentration of 6.67% and allowed to stand 17 hours at a temperature of 10° C. The test was originally developed by Oscar T. Bloom.

The composition comprises, for the remaining percent amount by weight, water and, optionally, one or more mixing additives.

“Mixing additives” refers to substances added to give the composition certain qualities or to improve its features and final rendering.

According to an embodiment, said mixing additives are one or more of the components chosen from the group that comprises: a silicone oil, a pigmented component.

In one embodiment, silicone oil is present in an amount less than 1% (w/w).

Preferably, the pigmented component is chosen from the group that comprises: powdered Vicenza earth, white titanium powder, white liquid pigment for food use.

The present invention also pertains to a method for preparing a composition for making a model for simulating a brain soft tissue according to any of the embodiments described above.

In particular, said method comprises the following steps:
a) mixing gelatin in water until the gelatin is completely dissolved;
b) heating the mixture of gelatin and water;
c) mixing glycerin with sorbitol;
d) heating the mixture of glycerin and sorbitol;
e) mixing the mixture of gelatin and water with the mixture of glycerin and sorbitol.

According to an embodiment of the invention, during or at the end of step e), one or more mixing additives selected from the group comprising a silicon oil and a pigmented component are mixed into the solution.

According to an embodiment, the mixture of gelatin and water obtained at the end of step a) comprises gelatin in an amount between 10% and 30% (w/w) inclusive, preferably between 15% and 25% (w/w) inclusive, even more preferably about 20% (w/w).

According to an embodiment, step a) is conducted at room temperature.

According to an embodiment, step a) is conducted for between 5 and 10 minutes inclusive. According to an embodiment, during step c) glycerin and sorbitol are mixed in equal parts.

According to an embodiment, the mixture during step b) is brought up to a temperature between 60° C. and 80° C. inclusive, preferably between 68° C. and 75° C. inclusive, even more preferably to about 70° C.

According to an embodiment, the mixture during step d) is brought up to a temperature between 60° C. and 80° C. inclusive, preferably between 68° C. and 75° C. inclusive, even more preferably to about 70° C. According to an embodiment, steps a) and c) of the method are carried out simultaneously.

According to an embodiment, steps b) and d) of the method are carried out simultaneously.

According to an embodiment, the steps of the method are carried out in the order in which they have been described.

The present: invention also pertains to a model 300 for simulating a brain soft tissue comprising a composition according to any of the embodiments described above.

In one embodiment, said model is a simulation model of a shapeless, structurally and morphologically undefined biological tissue.

In one embodiment, said model is a simulation model of a structurally and morphologically defined anatomical portion, such as the brain, or a portion of the brain, or the encephalon, or a portion of the encephalon.

The term “soft tissue” means any organic human tissue, both healthy and pathological, which has a lower density than bone tissue. For the purpose of the present invention, as already specified, “soft tissue” will be considered to be the encephalon, a portion of the encephalon, or tissues constituting the encephalon.

As mentioned above, the main subject matter of the present invention is a model for simulating a brain soft tissue as specified above and which is also capable of simulating a portion of the brain affected by a disease, and in particular affected by neoplasm.

Such a model comprises a first portion 301 for simulating a healthy tissue and a second portion 302 for simulating a neoplastic tissue.

According to an embodiment, said first portion and said second portion comprise a composition according to any of the embodiments described above.

In other words, a model for simulating a brain soft tissue affected by neoplasm according to the present invention comprises a first portion 301 for simulating a healthy tissue and a second portion 302 for simulating a neoplastic tissue. Further, the first portion 301 and the second portion 302 each comprise a composition comprising water, gelatin, glycerin and sorbitol, wherein the content by weight of glycerin and sorbitol is predominant over the content by weight of gelatin. In addition, the first portion 301 comprises a liquid dye and the second portion 302 comprises at least one powdered pigment.

According to an embodiment, the liquid dye in the first portion 301 is a liquid dye for food use and wherein the powdered pigment is a mineral type pigment.

According to an embodiment, the liquid dye in the first portion is a mixture of at least two liquid dyes selected from the group comprising: a yellow dye for food use, a white dye for food use, a brown dye for food use, a black dye for food use, and a red dye for food use.

Preferably, the liquid dye in the first portion is a mixture consisting of at least 70% white dye.

According to an embodiment, the liquid dye in the first portion 301 is a mixture consisting of a yellow dye for food use, a white dye for food use, a brown dye for food use, a black dye for food use, and a red dye for food use. This allows for proper coloring similar to white matter brain tissue while ensuring ultrasound passage for imaging.

Preferably, each liquid dye for food use is composed of a number of ingredients, which will also be referred to below by reference to the European food additive coding (e.g., EXXX).

Preferably, the yellow liquid dye contains the dye: E102; white liquid dye contains the dye: E171; red liquid dye contains the dye: E129; brown liquid dye contains the mixture of dyes: E155, E153, E102, E133;

black liquid dye contains the dye: E153.

Preferably, the yellow liquid dye is composed of glucose syrup, sugar, water, humectant: E422; dye: E102; modified starch, thickener: E406; acidity corrector: E330; preservative: E202.

Preferably, the white liquid dye is composed of dye: E171; humectant: E422; water.

Preferably, the red liquid dye is composed of glucose syrup, sugar, water, humectant: E422; dye: E129; modified starch, thickener: E406; acidity corrector: E330; preservative: E202.

Preferably, the brown liquid dye is composed of glucose syrup, sugar, water, humectant: E422; dyes: E155, E153, E102, E133; modified starch, thickener: E406; acidity corrector: E330; preservative: E202.

Preferably, the black liquid dye is composed of glucose syrup, sugar, water, humectant: E422; dye: E153; modified starch, thickener: E406; acidity corrector: E330; preservative: E202.

According to an embodiment, the powdered pigment of the second portion comprises one or more components selected from the group comprising: calcium carbonate (CaCO₃), hematite (Fe₂O₃), iron hydroxide (Fe(OH)₂), and calcium sulfate (CaSO₄).

According to an embodiment, the powdered pigment of the second portion consists of at least calcium carbonate (CaCO₃) and hematite (Fe₂O₃) and possibly also iron hydroxide (Fe(OH)₂) and calcium sulfate (CaSO₄). This allows adequate coloring of the second portion simulating the neoplasm and at the same time allows adequate echogenicity of the tissue for ultrasound detection.

Preferably, therefore, the first portion simulates the white matter of the brain and the second portion the neoplastic matter.

According to an embodiment, the percent amount by weight of glycerin comprised in said first portion is different from the amount of glycerin comprised in said second portion.

According to an embodiment, the percent amount by weight of sorbitol comprised in said first portion is different from the amount of sorbitol comprised in said second portion.

According to an embodiment, the ratio of sorbitol to glycerin in the first portion is different from the ratio of sorbitol to glycerin in the second portion.

According to an embodiment, the percent amount by weight of glycerin comprised in said first portion is greater than the amount of glycerin comprised in said second portion.

According to an embodiment, the percent amount by weight of sorbitol comprised in said first portion is greater than the amount of glycerin comprised in said second portion, at equal weight.

According to an embodiment, gelatin and glycerin are comprised in said first portion in a ratio between 1:20 and 1:30 inclusive.

According to an embodiment, gelatin and sorbitol are comprised in said first portion in a ratio between 1:20 and 1:30 inclusive.

The person skilled in the art will understand that, depending on the choice of ratios between the components, the above-described variants related to percent amount by weight will be combinable in a coherent manner.

According to an embodiment, in said first portion gelatin is present in an amount between 1% and 3% (w/w).

According to an embodiment, in said first portion glycerin is present in an amount between 43% and 46% (w/w) inclusive.

According to an embodiment, in said first portion sorbitol is present in an amount between 43% and 46% (w/w) inclusive.

According to an embodiment, gelatin and glycerin are comprised in said second portion in a ratio between 1:10 and 1:25 inclusive.

According to an embodiment, gelatin and sorbitol are comprised in said second portion in a ratio between 1:10 and 1:25 inclusive.

According to an embodiment, in said second portion gelatin is present in an amount between 1% and 4% (w/w) inclusive.

According to an embodiment, in said second portion glycerin is present in an amount between 38% and 45% (w/w) inclusive.

According to an embodiment, in said second portion sorbitol is present in an amount between 38% and 45% (w/w) inclusive.

According to an embodiment, the pigmented components comprised in said first portion and second portion, respectively, are different.

Advantageously, in the event that the percent amount by weight of gelatin, sorbitol, and glycerin comprised in said first portion were equal to the percent amount by weight of gelatin, sorbitol, and glycerin comprised said in second portion, respectively, it would still be possible to distinguish and identify said first portion and said second portion by virtue of the different coloring given by the different pigmented component.

According to an embodiment, said second portion is entirely embedded in said first portion.

The term “embedded” means that the second portion is entirely surrounded by said first portion, so that the outer surface of the second portion is entirely in contact with the first portion.

According to an embodiment, the production method of the simulation model of the invention is comprised in the group that comprises: casting in molds.

The present invention pertains also to the use of the composition according to any of the above-described embodiments to make a model of a brain soft tissue suitable for use in surgical training procedures.

The present invention also pertains to the use of a liquid dye for food use and powdered pigment for making a model for simulating brain soft tissue affected by neoplasm suitable for use in surgical training procedures.

The present invention also pertains to the use of the simulation model of a brain soft tissue according to any of the above-described embodiments in surgical training procedures.

Innovatively, the present invention provides a composition, a composition production method, and a model that may be used in place of the known art for surgical training procedures.

Advantageously, it is possible to vary the ratios between the components in the intervals specified in the embodiments of the composition to obtain a composition with different texture and different tactile and visual aspects for the operator, but still falling within the tactile and visual sensations as similar to reality as possible.

Further, the present invention makes it possible to vary the ratios of the amount of gelatin, glycerin and sorbitol in the composition and their percent amounts by weight to the total to reproduce the texture of brain soft tissue.

In particular, it is possible to vary the related ratios between the amounts of gelatin, glycerin and sorbitol in the composition and their percent amounts by weight to total weight to reproduce the texture and tactile and visual aspects of the white matter of the brain.

In particular, it is possible to vary the related ratios between the amounts of gelatin, glycerin and sorbitol in the composition and their percent amounts by weight to total weight to reproduce the texture and tactile and visual aspects of a neoplastic brain tissue.

In a particularly advantageous way, the components of the composition according to the invention and the method for producing it allow for obtaining a composition and a model that is stable over time.

Advantageously, in the model produced by means of a composition comprising silicone oil, the surface of the model is moist creating a “greasy” and “oily” effect, so as to simulate the real surface appearance of the human brain.

It should be noted that such above-mentioned effect is limited to the outer surface of the model.

Advantageously, by adding a pigmented component to the composition, it is possible to vary the visual appearance of the composition so that it resembles the color of the real brain soft tissue.

Advantageously, it is possible to provide for a model that comprises portions of different coloring, for example, a first white portion for simulating the white portion of the brain and a second portion of a different color for simulating neoplastic tissue.

Advantageously, the second portion for simulating a neoplastic tissue having a different color is easily identified and distinguishable from the first portion for simulating the white portion of the brain.

Innovatively, moreover, while providing adequate tactile and visual tissue adherence, the model according to the present invention enables the use of the usual ultrasonographic imaging equipment. In particular, in the model providing for the first portion (white matter) and the second portion (neoplasm), the use of different types of dye products surprisingly made it possible to correctly simulate the distinction between healthy tissue (first portion) and pathological tissue (second portion) on ultrasound. This allows the surgical operator not only to obtain an adequate tactile and visual response, but also a simulated response from the point of view of ultrasonographic imaging that is close to reality. In this way, the surgical operator, with a single model, is able to train in both the surgical act and ultrasonographic imaging, which is useful, for example, as a guide to resection.

Advantageously, a user may practice the surgical technique on the model of the invention with the necessary surgical instruments, such as scalpels and ablation systems and aspirators.

It is apparent that, to the embodiments of the above-mentioned composition, the production method of the composition and the model for simulating a brain soft tissue, a person skilled in the art, in order to meet specific needs, could make variants or substitutions of elements with functionally equivalent ones.

These variants are also contained within the scope of protection as defined by the following claims. Moreover, each variant described as belonging to a possible embodiment may be implemented independently of the other variants described.

### EXAMPLES and QUESTIONNAIRE

To prove the effectiveness of the present invention, a questionnaire was conducted on multiple models for simulating a brain soft tissue affected by neoplasm, made according to some variant embodiments of the present invention. The prepared models affected by neoplasm, hereinafter also simply referred to as test models, comprise a first simulation portion of healthy tissue and a second simulation portion of neoplastic tissue. Each test model covered by the questionnaire was made with a different composition. In particular, the first simulation portion of healthy tissue and the second simulation portion of neoplastic tissue of each test model were made with different compositions. In particular, for the implementation of the first portion of the test models, a composition was chosen comprising:
gelatin in an amount between 1% and 3% (w/w) inclusive;
glycerin in an amount between 43% and 46% (w/w) inclusive;
sorbitol in an amount between 43% and 46% (w/w) inclusive;

In particular, for the implementation of the second portion of the test models, a composition was chosen comprising:
gelatin in an amount between 1% and 4% (w/w) inclusive;
glycerin in an amount between 38% and 45% (w/w) inclusive;
sorbitol in an amount between 38% and 45% (w/w) inclusive.

The resulting test models were tested by fifteen subjects. Each subject tested all of the multiple test models prepared for conducting the questionnaire.

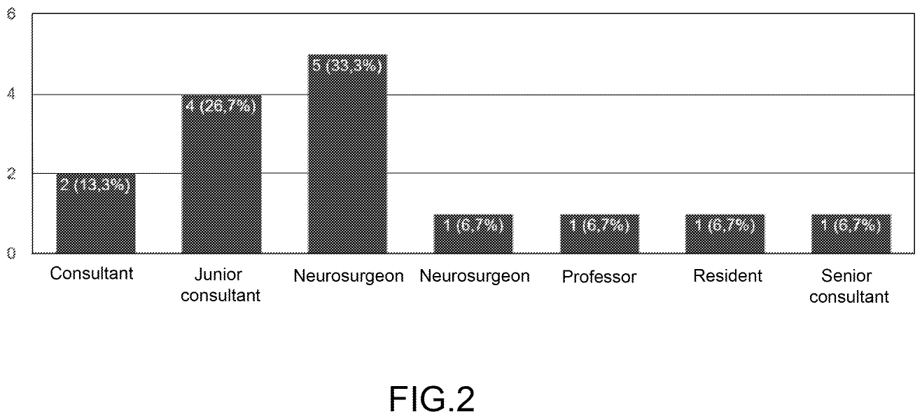

FIG. 2-5 schematically show information relating to the subjects interviewed.

FIG. 2 shows the job positions held by the subjects interviewed when they filled out the questionnaire.

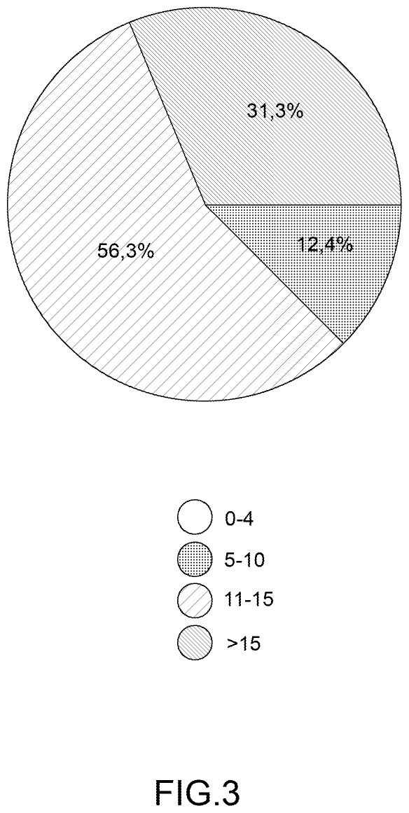

FIG. 3 shows in a pie chart the percentage of subjects interviewed having a number of years of experience in the indicated ranges.

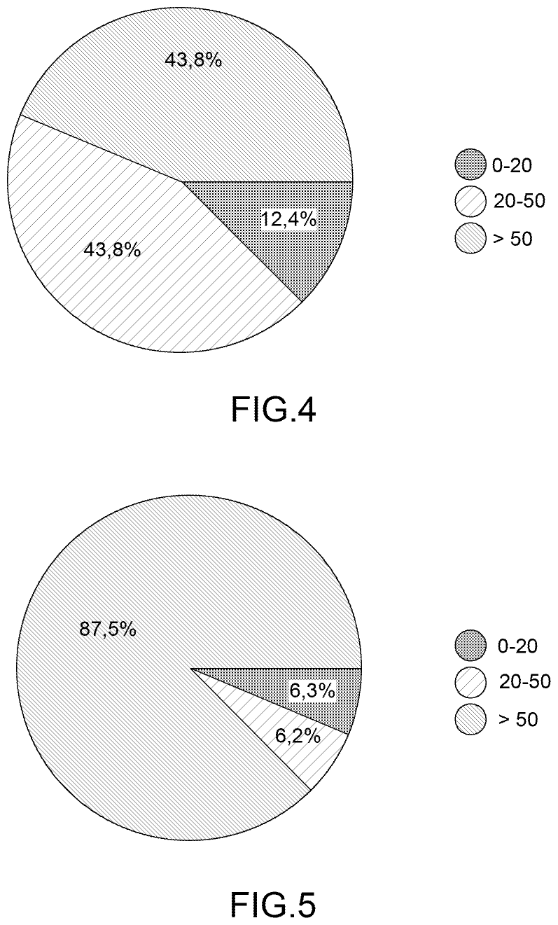

FIG. 4 shows the number of brain tumor resections (intrinsic tumors only) completed by the subjects interviewed, operating as the first operator in their professional careers.

FIG. 5 shows the number of brain tumor resections (intrinsic tumors only) completed by the subjects interviewed, operating as first and second operator in their professional careers.

As may be seen from the information shown in FIG. 2-5, the subjects interviewed have different degrees of experience, hold different job positions, and have completed different numbers of brain tumor resections. Therefore, the pool of subjects interviewed appears to be sufficiently heterogeneous.

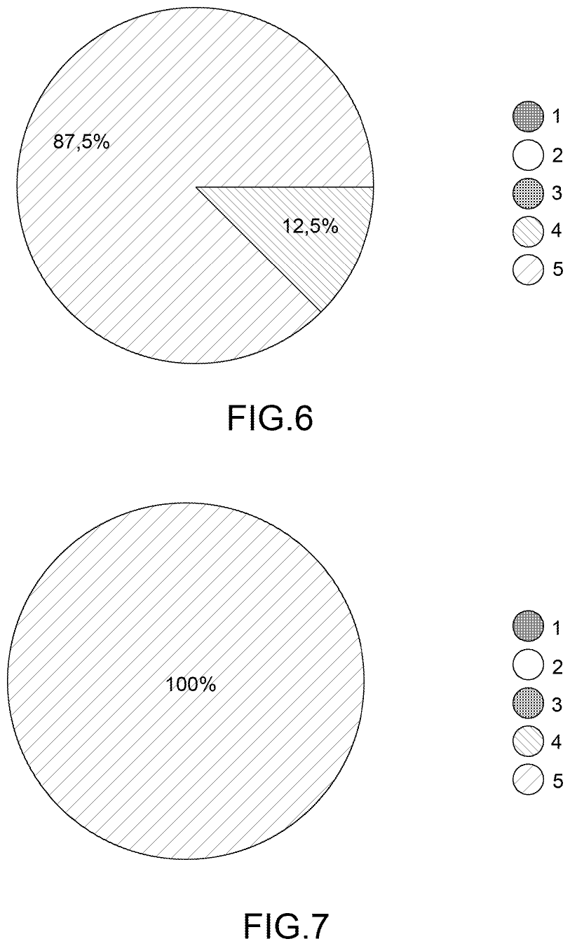

FIG. 6-12 show schematically the results to the questions asked during the test related to the prepared models. The answers to each question have been grouped into a single pie chart for greater immediacy and ease of analysis of the results.

In response to each question, each subject expressed his or her opinion with a graduated value from 1 to 5, wherein value 1 is “completely disagree,” and value 5 is “completely agree.”

FIG. 6-8 show in schematic form the results of the responses given by the subjects interviewed regarding the healthy tissue simulation portion of the test models.

The subjects were asked to evaluate the surface anatomical accuracy of the healthy tissue simulation portion of the test models when compared with that of the brain/cerebellum.

The pie chart in FIG. 6 shows the result of evaluating the surface anatomical accuracy of the test models. As may be seen, the anatomical models made for the test meet the requirements for surface anatomical accuracy.

The subjects were asked to evaluate whether the tactile sensation in manipulating the healthy tissue simulation portion of the test models was realistic.

The pie chart in FIG. 7 shows the result of the assessment of tactile sensation in manipulating the healthy tissue simulation portion of the test models. As may be seen, the tactile feel of the healthy tissue simulation portion of the test models appears realistic.

The subjects were asked to evaluate whether the visual appearance in the coloring of the healthy tissue simulation portion of the test models was realistic.

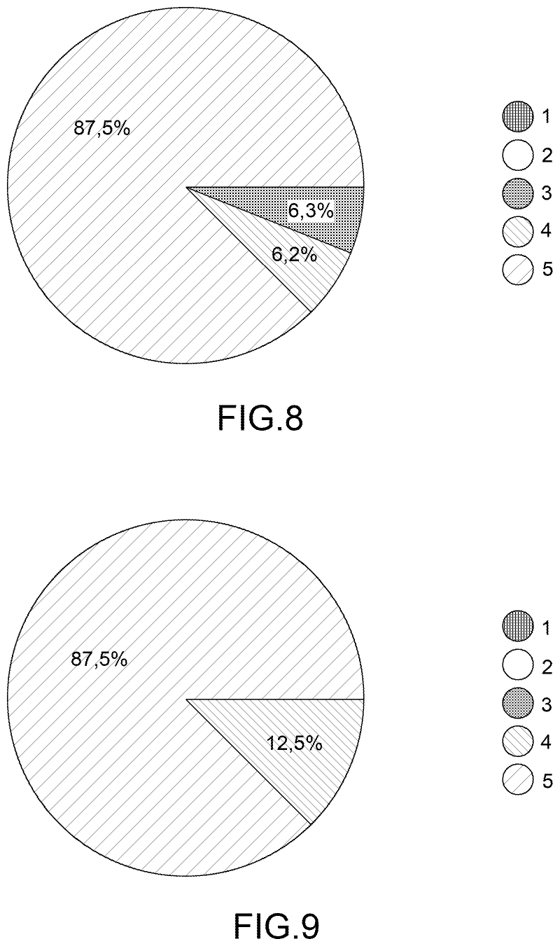

The pie chart in FIG. 8 shows the result of visual appearance evaluation in the coloring of the healthy tissue simulation portion of the test models. As is shown, the coloring of the healthy tissue simulation portion of models the test appears realistic.

FIG. 9-11 show in schematic form the results of the responses given by the subjects interviewed regarding the neoplastic tissue portion of the test models submitted to them.

The subjects were asked to evaluate the accuracy of identifying the portion of neoplastic tissue in test models.

The pie chart in FIG. 9 shows the result of evaluating the identification of the simulation portion of a neoplastic tissue in the test models. As may be seen, the simulation portion of neoplastic tissue was accurately identified.

The subjects were asked to evaluate whether the tactile sensation in manipulating the neoplastic tissue simulation portion of the test models was realistic.

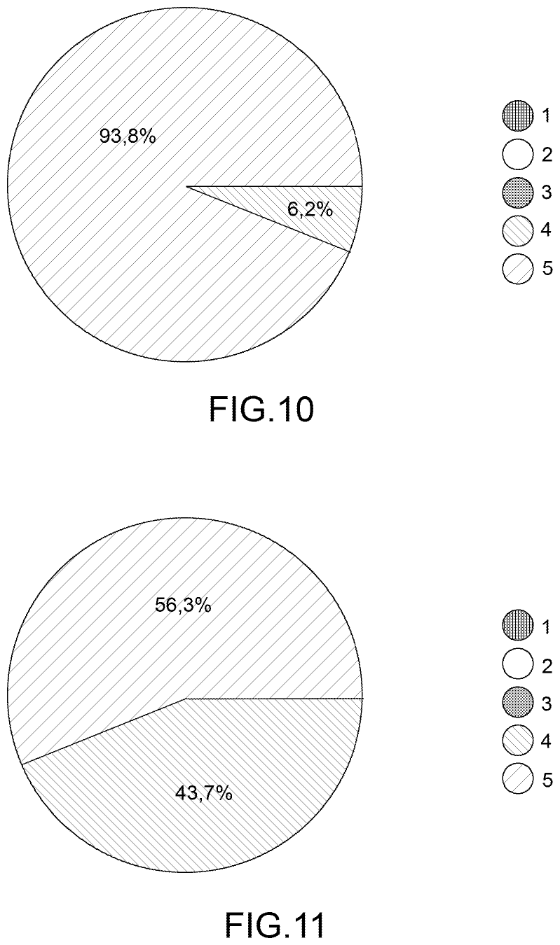

The pie chart in FIG. 10 shows the result of the assessment of tactile sensation in manipulating the simulation portion of a neoplastic tissue of the test models. As may be seen, the tactile sensation of the neoplastic tissue simulation portion of the test models appears realistic.

The subjects were asked to evaluate whether the visual appearance in the coloring of the neoplastic tissue simulation portion of the test models was realistic.

The pie chart in FIG. 11 shows the result of the visual appearance evaluation in the coloring of the simulation portion of a neoplastic tissue in the test models. As may be seen, the color of the neoplastic tissue simulation portion of the test models appears realistic.

The subjects were asked to evaluate whether the resection of the simulation portion of a neoplastic tissue from the simulation portion of healthy tissue in the test models was similar to actual experience.

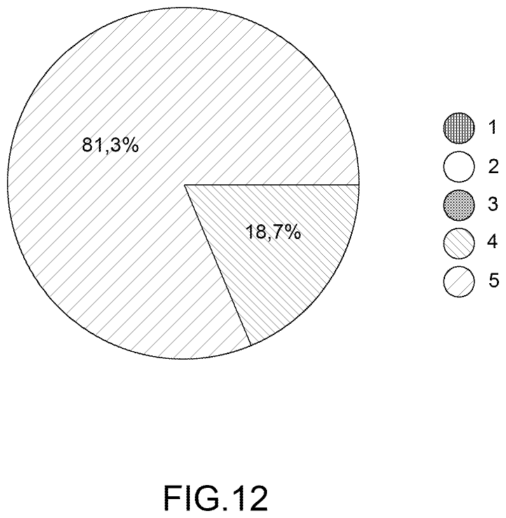

The pie chart in FIG. 12 shows the result of the evaluation of the realism of the resection procedure of the second simulation portion of a neoplastic tissue from the first simulation portion of healthy tissue of the test models. As may be seen, the resection of the simulation portion of f neoplastic tissue appears realistic.

From the test conducted and the answers obtained to the questions of the questionnaire, it may be concluded that the objects of the present invention are fully achieved.

1. A model for simulating a brain soft tissue affected by neoplasm, comprising:
a first portion for simulating a healthy tissue; and
a second portion for simulating a neoplastic tissue,
wherein said first portion and said second portion each comprise a composition comprising water, gelatin, glycerin and sorbitol, wherein a content by weight of glycerin and sorbitol is predominant over a content by weight of gelatin,
wherein the first portion comprises a liquid dye, and wherein the second portion comprises at least one powdered pigment.

2. The model of claim 1, wherein the liquid dye of the first portion is a liquid dye for food use and wherein the at least one powdered pigment is a mineral type pigment.

3. The model of claim 1, wherein the liquid dye of the first portion is a mixture of at least two liquid dyes selected from the group consisting of: a yellow dye for food use, a white dye for food use, a brown dye for food use, a black dye for food use, and a red dye for food use.

4. The model of claim 3, wherein the liquid dye of the first portion is a mixture consisting of at least 70% of the white dye for food use.

5. The model to of claim 3, wherein the liquid dye of the first portion is a mixture consisting of the yellow dye for food use, the white dye for food use, the brown dye for food use, the black dye for food use, and the red dye for food use.

6. The model of claim 1, wherein the at least one powdered pigment of the second portion comprises one or more components selected from the group consisting of: calcium carbonate (CaCO₃), hematite (Fe₂O₃), iron hydroxide (Fe(OH)₂) and calcium sulfate (CaSO₄).

7. The model of claim 1, wherein the at least one powdered pigment of the second portion consists of at least calcium carbonate (CaCO₃) and hematite (Fe₂O₃) and possibly also iron hydroxide (Fe(OH)₂) and calcium sulfate (CaSO₄).

8. The model of claim 1, wherein percent amounts by weight of glycerin and sorbitol in said first portion are different from percent amounts by weight of glycerin and sorbitol in said second portion, respectively.

9. The model of claim 1, wherein:
the gelatin is present in an amount at most equal to 10% (w/w);
the glycerin is present in an amount between 30% and 55% (w/w) inclusive; and
the sorbitol is present in an amount between 30% and 55% (w/w) inclusive.

10. The model of claim 1, wherein the gelatin is a 300 Bloom gelatin.

11. The model of claim 1, further comprising silicone oil.

12. The model of claim 1, wherein percent amounts by weight of glycerin and sorbitol in said first portion are greater than percent amounts by weight of glycerin and sorbitol in said second portion, respectively.

13. The model of claim 1, wherein
in said first portion:
the gelatin and the glycerin are in a ratio between 1:20 and 1:30 inclusive;
the gelatin and the sorbitol are in a ratio between 1:20 and 1:30 inclusive; and wherein
in said second portion:
the gelatin and the glycerin are in a ratio between 1:10 and 1:25 inclusive; and
the gelatin and the sorbitol are in a ratio between 1:10 and 1:25 inclusive.

14. The model of claim 1, wherein said second portion is entirely embedded in said first portion.

15. A method for making a model for simulating a brain soft tissue affected by neoplasm suitable to be used in surgical training procedures, the method comprising utilizing a liquid dye for food use and at least one powdered pigment.

16. A method for performing surgical training procedures, the method comprising utilizing the model of claim 1.

17. The model of claim 1, wherein:
the gelatin is present in an amount at most equal to 5% (w/w);
the glycerin is present in an amount between 35% and 50% (w/w) inclusive; and
the sorbitol is present in an amount between 35% and 50% (w/w) inclusive.

18. The model of claim 1, wherein:
the gelatin is present in an amount between 1% and 4% (w/w);
the glycerin is present in an amount between 38% and 46% (w/w) inclusive; and
the sorbitol is present in an amount between 38% and 46% (w/w) inclusive.
